(19) United States
(12) Patent Application Publication
(10) Pub. No.: US 2025/0200375 A1
(43) Pub. Date: Jun. 19, 2025

(54) SYSTEMS AND METHODS FOR TRAINING PHYSICS-INFORMED NEURAL NETWORK SURROGATE MODELS TO MODEL PHYSICAL PROBLEMS USING THE FINITE ELEMENT METHOD

(71) Applicant: Rutgers, The State University of New Jersey, New Brunswick, NJ (US)

(72) Inventors: Ryan B. Sills, Skillman, NJ (US); Manish Vasoya, Franklin Park, NJ (US)

(73) Assignee: Rutgers, The State University of New Jersey, New Brunswick, NJ (US)

(21) Appl. No.: 19/072,424

(22) Filed: Mar. 6, 2025

Related U.S. Application Data
(63) Continuation-in-part of application No. PCT/US2024/027843, filed on May 3, 2024.
(60) Provisional application No. 63/500,438, filed on May 5, 2023.

(51) Int. Cl. G06N 3/084; G06F 30/23; G06N 3/0464

(52) U.S. Cl. CPC G06N 3/084; G06F 30/23; G06N 3/0464

(57) ABSTRACT

Systems and methods for training physics-informed neural network (PINN) surrogate models to model physical problems are provided. The method may comprise coupling, using a processor, one or more convolutional neural networks (CNNs) with a finite element method (FEM). The coupling may comprise calculating, for a finite element mesh comprising a plurality of finite elements, an internal force vector, P, a force vector, F, and a tangent stiffness matrix, K_{T}, using the FEM. Each finite element may comprise one or more finite element nodes. The coupling may further comprise applying a CNN to the finite element mesh to obtain a solution to a physical problem. The CNN may be trained on a loss function, and the loss function may incorporate the internal force vector, P, and the force vector, F.

### CROSS-REFERENCE TO RELATED APPLICATIONS

This application is a continuation-in-part of and claims priority under 35 U.S.C. § 120 to International Application No. PCT/US2024/027843, filed May 3, 2024, and published in the English language, which claims the benefit of U.S. Provisional Application No. 63/500,438, filed May 5, 2023. The entire contents of the foregoing applications are incorporated by reference herein.

### STATEMENT REGARDING FEDERALLY SPONSORED RESEARCH

This invention was made with government support under grant number 2237039 awarded by the National Science Foundation. The government has certain rights in the invention.

### TECHNICAL FIELD

The present disclosure relates to systems and methods for training physics-informed neural network (PINN) surrogate models to model physical problems.

### BACKGROUND

Workhorse convolution operators used in convolutional neural networks assume a uniform, pixelated grid (e.g., an image). Such a grid provides a poor representation of irregular domains, leading to non-conformal representations at the boundaries. Finite element meshes, however, are conformal to boundaries, but elements have irregular shapes.

If the convolution operator is not rotationally equivariant, then any arbitrary rotation of the input can yield inaccurate results. This is an undesirable consequence that limits potential application of the technology. The rotational invariance of the laws of physics demands that solutions to physical problems satisfy rotational equivariance.

The present disclosure describes systems and methods related to the above.

### SUMMARY

In one aspect of the present disclosure, a method for training physics-informed neural network (PINN) surrogate models to model physical problems is provided. The method may include coupling, using a processor, one or more convolutional neural networks (CNNs) with the finite element method (FEM). The coupling may include calculating, for a finite element mesh comprising a plurality of finite elements, an internal force vector, P, a force vector, F, and a tangent stiffness matrix, K_{T}, using the FEM. Each finite element may include one or more finite element nodes. The coupling may further include applying a CNN to the finite element mesh to obtain a solution to a physical problem. The CNN may be trained on a loss function, and the loss function may incorporate the internal force vector, P, and the force vector, F.

In another aspect of the present disclosure, the plurality of finite elements may represent a spatiotemporal variation of one or more physical quantities into which the physical problem can be divided.

In another aspect of the present disclosure, the one or more physical quantities may include one or more of the following: one or more quantities pertaining to solid mechanics, fluid mechanics, electromagnetic radiation, and heat transfer.

In another aspect of the present disclosure, the loss function may include:

$$ℒ ( d ) = ‖ P ( d ) - F ‖$$

where d denotes a solution vector of the physical problem.

In another aspect of the present disclosure, when the physical problem includes a linear physical problem, the internal force vector, P, may include: P(d)=Kd, where K is a stiffness matrix.

In another aspect of the present disclosure, when the physical problem includes a non-linear physical problem, the applying the CNN to each finite element node may include iteratively applying a CNN for each of a plurality of solution vectors, d.

In another aspect of the present disclosure, backpropagation may be used to update hyperparameters by computing derivatives of the loss function with respect to a plurality of solution vectors, d.

In another aspect of the present disclosure, the derivatives of the loss function with respect to the plurality of solution vectors may include:

$$\frac{\partial ℒ}{\partial d} = {K}_{T} \frac{R}{‖ R ‖}$$

where:

R is a residual vector including: R=P(d)−F; and

K_{T} is a tangent stiffness matrix including:

$${K}_{T} = \frac{\partial R}{\partial d} .$$

In another aspect of the present disclosure, the applying the CNN may include applying a convolutional operator, using a stencil tensor, S, to perform one or more convolutions.

In another aspect of the present disclosure, the stencil tensor, S, may be a collection of points defined based on Gaussian quadrature, and one or more convolutions of the CNN may be enabled by placing the stencil tensor over top of a finite element node, of one or more finite element nodes, and then evaluating a field at each of one or more stencil points using an inverse isoparametric map.

In another aspect of the present disclosure, convolution operator is substantially rotationally equivariant

In another aspect of the present disclosure, the convolution operator may include:

$${O}_{a {c}_{0} {m}_{0}}^{( {l}_{0} )} \approx \frac{{π}^{2} {r}_{c}}{4} {\sum }_{α = 1}^{{n}_{gp , α}} {\sum }_{β = 1}^{{n}_{gp , β}} {\sum }_{γ = 1}^{{n}_{gp , γ}} {w}_{α} {w}_{β} {w}_{γ} \cdot {\tilde{r}}_{a , γ}^{2} sin {\tilde{θ}}_{β} \cdot {C}_{( {l}_{f} , {m}_{f} ) ( {l}_{i} , {m}_{i} )}^{( {l}_{0} , {m}_{o} )} \cdot {R}_{{c}_{i} {c}_{0}}^{( {l}_{i} , {l}_{f} )} ( {\tilde{r}}_{a , γ} ) \cdot {Y}_{{m}_{f}}^{( {l}_{f} )} ( {\tilde{θ}}_{β} , {\tilde{ϕ}}_{α} ) \cdot {I}_{{c}_{i} {m}_{i}}^{( {l}_{i} )} ( {\tilde{r}}_{a , γ} , {\tilde{θ}}_{β} , {\tilde{ϕ}}_{α} )$$

where:
l is a rotation order, cᵢ is an input channel index, and m is a representation index;
O_{ac}_{ₒ}ₘ_{ₒ}^{(l}^{ₒ}⁾ is an output at node a for an output channel cₒ, the rotation order lₒ, and the representation index m₀;
a number of the input channels, cᵢ, and a number of the output channels, cₒ, can differ;
r_{c} is a cut-off radius within a spherical neighborhood of node a;
\tilde{r}_{a,γ}, \tilde{θ}_{β}, and \tilde{ϕ}_{α} are spherical coordinates, the spherical coordinates including:

$${\tilde{r}}_{a , γ} = \frac{{r}_{c}}{2} ( {ξ}_{γ} + 1 ) , {\tilde{θ}}_{β} = \frac{π}{2} ( {ξ}_{β} + 1 ) ,$$

and \tilde{ϕ}_{α}=ϕ(ξ_{α}+1);
where: ξ_{α}, ξ_{β}, and ξ_{γ} are positions of Gauss points within an interval of [−1, 1]
n_{gp,γ}, n_{gp,β}, and n_{gp,γ} are numbers of the Gauss points, evaluated at the spherical coordinates \tilde{r}_{a,γ}, \tilde{θ}_{β}, and \tilde{ϕ}_{α};
w_{α}, w_{β}, and w_{γ} are Gauss weights;
C₍ₗ_{_{f}}_{,m}_{_{f}}₎₍ₗ_{ᵢ}_{,m}_{ᵢ}₎^{(l}^{ₒ}^{,m}^{ₒ}⁾ are Clebsch-Gordon coefficients;
R_{c}_{ᵢ}_{c}_{ₒ}^{(l}^{ᵢ}^{,l}^{_{f}}⁾(r_{a,γ}) is a radial weight function;
Yₘ_{_{f}}^{(l}^{_{f}}⁾(\tilde{θ}_{B}, \tilde{ϕ}_{α}) is a spherical harmonics component; and
l_{c}_{ᵢ}ₘ_{ᵢ}^{(l}^{ᵢ}⁾(\tilde{r}_{a,γ}, \tilde{θ}_{β}, \tilde{ϕ}_{α}) is an input field to a particular convolutional neuron.

In another aspect of the present disclosure, the radial weight function may be expanded in a set of basis functions, the basis functions may include:

$${R}_{{c}_{i} {c}_{0}}^{( {l}_{i} , {l}_{f} )} ( r ) = {\sum }_{p = 1}^{{p}_{max}} {α}_{{c}_{i} {c}_{o} p}^{( {l}_{f} , {l}_{i} )} {g}_{p} ( r )$$

where:
gₚ(r) is a p-th radial basis function;
r is a radius; and
a_{c}_{ᵢ}_{c}_{ₒ}ₚ^{(l}^{_{f}}^{,l}^{ᵢ}⁾ are trainable parameters.

In another aspect of the present disclosure, the set of basis functions may include cosines and Chebyshev polynomials, the set of basis functions may include:

$${g}_{1} ( r ) = 1 + cos ( \frac{π r}{{r}_{c}} ) ;$$

$${g}_{p} ( r ) = \frac{1}{4} [ 1 - {T}_{p - 1} ( x ) ] [ 1 + cos ( \frac{π r}{{r}_{c}} ) ] , p \geq 2 ; and$$

$$x = 1 - 2 ( \frac{exp ( - λ ( r / {r}_{c} - 1 ) - 1 )}{exp ( - λ ) - 1} ) ;$$

where:
Tₚ is a p-th Chebyshev polynomial of a first kind;
and λ is a parameter.

In another aspect of the present disclosure, the input field may be specified using a finite element approximation, the input field may include:

$${I}_{c m}^{( l )} ( x ) = {\sum }_{e} {\sum }_{n ∈ e} {d}_{c m n}^{( l )} {\tilde{N}}^{n e} ( x )$$

where:
d_{cmn}^{(l)} is a nodal value for the field I_{cm}^{(l)} at node n;
Ñ^{ne}(⋅) is a shape function evaluated in a physical domain for node n contained in an element e; and
summations are performed for all the elements e and all the nodes n.

In another aspect of the present disclosure, the convolution operator may be a numerical approximation of an analytical expression, the analytical expression may include:

$${O}_{a {c}_{0} {m}_{0}}^{( {l}_{0} )} = {\int }_{0}^{2 π} {\int }_{0}^{π} {\int }_{0}^{{r}_{c}} {r}^{2} sin θ \cdot {C}_{( {l}_{f} , {m}_{f} ) ( {l}_{i} , {m}_{i} )}^{( {l}_{0} , {m}_{o} )} \cdot {R}_{{c}_{i} {c}_{0}}^{( {l}_{i} , {l}_{f} )} ( {r}_{a} ) \cdot {Y}_{{m}_{f}}^{( {l}_{f} )} ( θ , ϕ ) \cdot {I}_{{c}_{i} {m}_{i}}^{( {l}_{i} )} ( r , θ , ϕ ) drd θ d ϕ$$

where rₐ is a radial distance from the node a and includes: rₐ=∥x−xₐ∥.

In another aspect of the present disclosure, an isoparametric mapping function may include:

$${x}_{i} ( {ξ}_{i} ) = {\sum }_{e} {\sum }_{n ∈ e} {X}_{i}^{n} {N}^{n e} ( {ξ}_{i} )$$

where:
Xᵢⁿ is an i-th coordinate of the node n in a physical domain; and
N^{ne}(ξᵢ) is an elemental shape function evaluated at a parent domain coordinate ξᵢ. A relationship between the parent domain and the physical domain may include:

$${\tilde{N}}^{n e} ( {x}_{i} ) = {N}^{n e} ( {ξ}_{i} ( {x}_{i} ) ) ;$$

where: the inverse isoparametric map may include ξᵢ(xᵢ).

In another aspect of the present disclosure, the calculating, for each finite element, the internal force vector, P, the force vector, F, and the tangent stiffness matrix, K_{T}, using the FEM, may include training a surrogate model to a plurality of finite elements of the one or more finite elements.

In another aspect of the present disclosure, the calculating, for the finite element mesh, the internal force vector, P, the force vector, F, and the tangent stiffness matrix, K_{T}, using the FEM, may include constructing a training case, and each training case may correspond to one or more ingredients necessary to establish a finite element problem.

In another aspect of the present disclosure, the one or more ingredients may include one or more of the following: a finite element mesh of a chosen geometry; one or more constitutive models to describe one or more substance behaviors in the one or more constitutive models; a set of boundary conditions; a set of source terms; and a set of body forces.

In another aspect of the present disclosure, a system for training PINN surrogate models to model physical problems is provided. The system may include a computing device, further including a processor and a memory configured to store programming instructions. The programming instructions, when executed by the processor, may be configured to cause the processor to couple one or more CNNs with the FEM. The coupling may include calculating, for a finite element mesh comprising a plurality of finite elements, an internal force vector, P, a force vector, F, and a tangent stiffness matrix, K_{T}, using the FEM. Each finite element may include one or more finite element nodes. The coupling may further comprise applying a CNN to the finite element mesh, to obtain a solution to a physical problem. The CNN may be trained on a loss function, and the loss function may incorporate the internal force vector, P, and the force vector, F.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is an example flowchart of a method for training physics-informed neural network (PINN) surrogate models to model physical problems, according to various embodiments of the present disclosure;

FIG. 2 illustrates a stencil tensor, S, applied to a finite element mesh at node n, according to various embodiments of the present disclosure;

FIGS. 3A-3C show example results for a simulation for a range of wedge angles, illustrating loss convergence during training (FIG. 3A), solution fields from FEM and a trained finite element PINN (FE-PINN) (FIG. 3B), and an FE-PINN error as a function of wedge angle after training with three wedged block geometries (FIG. 3C), according to various embodiments of the present disclosure; and

FIG. 4 illustrates example elements of a computing device, according to various embodiments of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

In this document, when terms such as “first” and “second” are used to modify a noun, such use is simply intended to distinguish one item from another and is not intended to require a sequential order unless specifically stated. In addition, terms of relative position such as “vertical” and “horizontal”, or “front” and “rear”, when used, are intended to be relative to each other and need not be absolute and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory may contain or receive programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “module” refers to a set of computer-readable programming instructions, as executed by a processor, which cause the processor to perform a specified function.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network-coupled computer systems so that the computer readable media may be stored and executed in a distributed fashion, such as, e.g., by a telematics server or a Controller Area Network (CAN).

Unless specifically stated or obvious from context, as used herein, the term “about” is understood as within a range of normal tolerance in the art, for example, within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

Hereinafter, systems and methods for training physics-informed neural network (PINN) surrogate models to model physical problems, according to embodiments of the present disclosure, will be described with reference tox c the accompanying drawings.

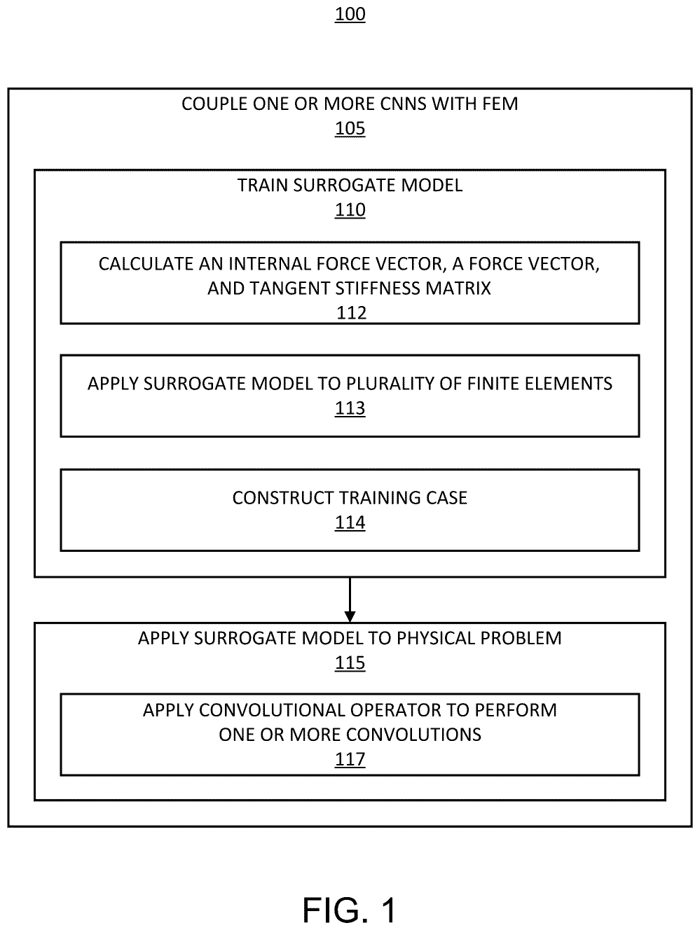

Referring to FIG. 1, an example method 100 for training physics-informed neural network (PINN) surrogate models to model physical problems is illustratively depicted, in accordance with various embodiments of the present disclosure.

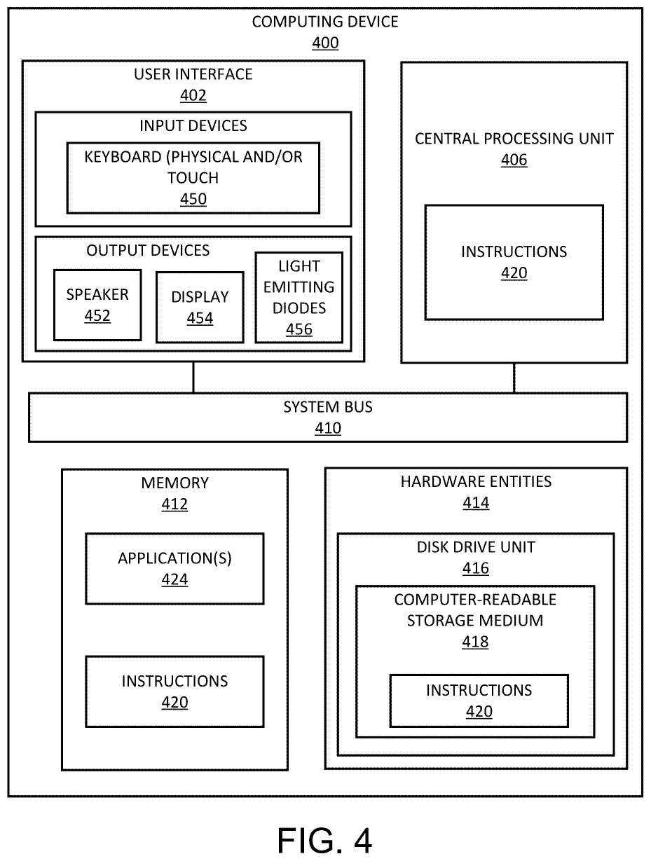

At 105, one or more convolutional neural networks (CNNs) may be coupled with a finite element method (FEM). According to various embodiments, the coupling may be performed using a computing device (e.g., computing device 400 as shown in FIG. 4). According to various embodiments, the coupling may comprise, at 110, training a surrogate model. According to various embodiments, training the surrogate model may comprise, at 112, calculating, for a finite element mesh comprising a plurality of finite elements, an internal force vector, P, a force vector, F, and a tangent stiffness matrix, K_{T}, using the FEM. Each finite element may comprise one or more finite element nodes.

According to various embodiments, the plurality of finite elements may represent a spatiotemporal variation of one or more physical quantities into which the physical problem can be divided. According to various embodiments, the one or more physical quantities may comprise one or more of the following: one or more quantities pertaining to solid mechanics, fluid mechanics, electromagnetic radiation, and heat transfer. According to various embodiments, d may denote a nodal solution vector. According to various embodiments, d may be a nodal solution vector for whatever field is of interest (e.g., temperature, displacement, etc.). This leads to a “physics-informed” neural network since the network is configured to “learn” one or more governing equations rather than “learning” one or more chosen solutions to the equations. This approach may be implemented for industries including, but not limited to, automotive, aviation, aerospace, defense, energy, oil & gas, and structural engineering industries.

The coupling may further comprise, at 115, applying a CNN to a finite element mesh to obtain a solution to a physical problem. According to various embodiments, the CNN may be trained on a loss function, and the loss function may incorporate the internal force vector, P, and the force vector, F. According to various embodiments, the loss function takes the form of Equation 1, where d denotes a solution vector of the physical problem.

$$ℒ ( d ) = ‖ P ( d ) - F ‖ \qquad Equation 1$$

According to various embodiments, the physical problem may comprise a linear physical problem, a non-linear physical problem, and/or a combination of one or more linear physical problems and/or non-linear physical problems. For example, the physical problem may comprise a linear physical problem. According to various embodiments, when the physical problem comprises a linear physical problem, the internal force vector, P, may be computed according to Equation 2.

$$P ( d ) = Kd \qquad Equation 2$$

where K is a stiffness matrix.

According to various embodiments, when the physical problem comprises a non-linear physical problem, the applying the CNN to a finite element node may comprise iteratively applying a CNN for each of a plurality of solution vectors, d.

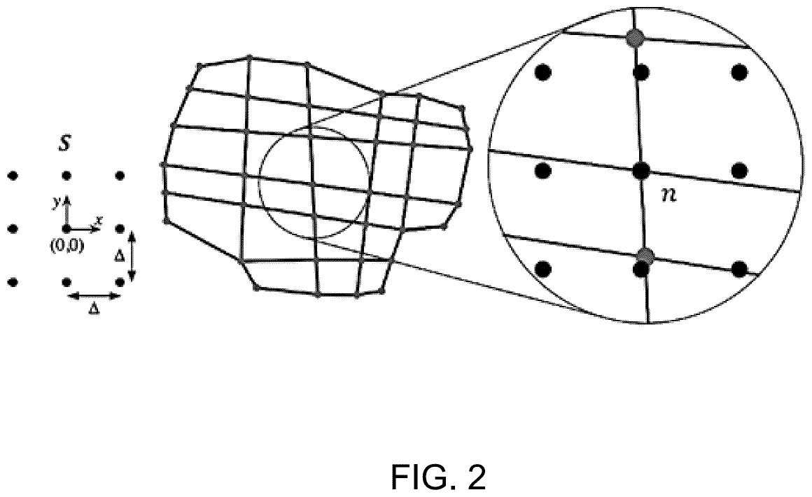

According to various embodiments, the applying the CNN may comprise, at 117, applying a convolutional operator, using a stencil tensor, S, (e.g., a non-uniform grid that is yet to be defined) to perform one or more convolutions. The stencil tensor, S, may be a regular N×N grid with spacing, Δ, as shown, e.g., in FIG. 2. In alternative embodiments, the stencil tensor, S, may be a collection of points based on Gaussian quadrature. In other alternative embodiments, the stencil tensor, S, may be another suitable distribution of points. It is noted, however, that other stencil tensors may be incorporated while maintaining the spirit and functionality of the present disclosure. According to various embodiments, pooling operations, unsampling operations, and/or other suitable operations may be incorporated, in addition to, or instead of, convolution operations, while maintaining the spirit and functionality of the present disclosure.

One or more convolutions of the CNN may be enabled by placing the stencil tensor, S, over top of a finite element node, of one or more finite element nodes, and then evaluating a field at each of the one or more stencil points, may be evaluated using an inverse isoparametric map. According to various embodiments, the convolution operator may take the form of Equation 3.

$${O}_{i} = {\sum }_{m = - α}^{α} {\sum }_{n = - α}^{α} I ( {x}_{i} + {S}_{m , n} , {P}_{m , n} ) {W}_{m , n} \qquad Equation 3$$

where Oᵢ is an output of a convolution for node i, xᵢ is a position vector of node i, W_{m,n} is a weight tensor for the convolution for node i, P_{m,n} is an additional parameter tensor used in convolution for node i, I(x) is an evaluation of the input field at position x, and α=(N−1)/2.

In alternate embodiments, one or more convolutions of the CNN may be intrinsically equivariant with respect to rotations in three-dimensional space. For example, an input field to a particular convolutional neuron may be represented by I_{cm}^{(l)}(x), where l is a rotation order, c is an input channel index, and m is a representation index. The representation index can span an inclusive range of values from −l to l. Values for the rotation order and the representation index can be assigned depending on a field being characterized by the input field. For example, the rotation index and the representation index are both zero if the input field is a scalar field. If, however, the input field is a vector field, then the rotation index is set to unity and the representation index is assigned values of m=−1; m=0; and m=1 to denote three components of a vector. The input field can be specified using a finite element mesh and expressed using a finite element approximation and may therefore take the form of Equation 4.

$${I}_{c m}^{( l )} ( x ) = {\sum }_{e} {\sum }_{n ∈ e} {d}_{c m n}^{( l )} {\tilde{N}}^{n e} ( x )$$

where d_{cmj}^{(l)} is a nodal value for the field I_{cm}^{(l)} at a node n, Ñ^{ne}(⋅) is a shape function evaluated in a physical domain for the node n contained in an element e. Summations are carried out for all of the elements and all of the nodes contained in each element.

A convolution of the CNN can be expressed as an integral and may take the form of Equation 5.

$${O}_{a} = {\int }_{{𝒩}_{a}} W ( x - {x}_{a} ) I ( x ) dx \qquad Equation 5$$

where Oₐ is an output at node a, xₐ is a position of node a, Nₐ is a neighborhood of node a used for the convolution, and W(⋅) is a convolutional weight function. To support rotational equivariance, Equation 5 can be limited to a spherical neighborhood of node a with a cut-off radius of r_{c}. Equation 5 can further be expressed in spherical coordinates, which may take the form of Equation 6.

$${O}_{a} = {\int }_{0}^{2 π} {\int }_{0}^{2 π} {\int }_{0}^{{r}_{c}} {r}^{2} sin θ W ( {r}_{a} , θ , ϕ ) I ( {r}_{a} , θ , ϕ ) drd θ d ϕ \qquad Equation 6$$

where a radial distance from node a can be expressed as rₐ=∥x−xₐ∥.

The convolutional weight function W(⋅) of Equation 6 can be constructed to be rotationally equivariant. For example, a tensor field networks approach can be used decompose the convolutional weight function W(⋅). Further, the convolutional weight function W(⋅) can be decomposed a product of a radial weight function and a spherical harmonics component. In some embodiments, the radial weight function may be expressed as R_{c}_{ᵢ}_{c}_{ₒ}^{(l}^{ᵢ}^{,l}^{_{f}}⁾(r) and the spherical harmonics component may be expressed as Yₘ_{_{f}}^{(l}^{_{f}}⁾(θ, ϕ). Further, the radial weight function may be expanded in a set of basis functions. For example, after expansion, the radial weight function may take the form of Equation 7.

$${R}_{{c}_{i} {c}_{0}}^{( {l}_{i} , {l}_{f} )} ( r ) = {\sum }_{p = 1}^{{p}_{max}} {α}_{{c}_{i} {c}_{o} p}^{( {l}_{f} , {l}_{i} )} {g}_{p} ( r ) \qquad Equation 7$$

where gₚ(r) is a p-th radial basis function, r is a radius position, and α_{c}_{ᵢ}_{c}_{ₒ}ₚ^{(l}^{_{f}}^{,l}^{ᵢ}⁾ are trainable parameters. In some embodiments, the set of basis functions of Equation 7 can be based on cosines and Chebyshev polynomials. For example, a possible set of basis functions may take the form of Equation 8.

$$\begin{matrix}{g}_{1} ( r ) = 1 + cos ( \frac{π r}{{r}_{c}} ) \\ {g}_{p} ( r ) = \frac{1}{4} [ 1 - {T}_{p - 1} ( x ) ] [ 1 + cos ( \frac{π r}{{r}_{c}} ) ] , p \geq 2 \\ x = 1 - 2 ( \frac{exp ( - λ ( r / {r}_{c} - 1 ) - 1 )}{exp ( - λ ) - 1} )\end{matrix} \qquad Equation 8$$

where Tₚ is a p-th Chebyshev polynomial of a first kind and A is a parameter. In alternative embodiments, the radial weight function, R_{c}_{ᵢ}_{c}_{ₒ}^{(l}^{ᵢ}^{,l}^{_{f}}⁾(r) may be any suitable function with adjustable parameters. For example, the radial weight function may be a fully-connected neural network.

To further promote rotational equivariance, the output of the convolution may be a representation in a three-dimensional rotation group. The three-dimensional rotation group (e.g. SO(3)) can be the group of all rotations about the origin of three-dimensional Euclidean space under the operation of composition. Further, Clebsch-Gordon coefficients may be used to represent the output from the convolution in SO(3). For example, the Clebsch-Gordon coefficients may be expressed by C₍ₗ_{_{f}}_{,m}_{_{f}}₎₍ₗ_{ᵢ}_{,m}_{ᵢ}₎^{(l}^{ₒ}^{,m}^{ₒ}⁾.

A rotationally equivariant form of Equation 6 can incorporate the expanded radial weight function of Equation 7, the spherical harmonics component, the decomposition of Equation 8, and the Clebsch-Gordon coefficients. For example, the rotationally equivariant form of Equation 6 may take the form of Equation 9.

$${O}_{a {c}_{0} {m}_{0}}^{( {l}_{0} )} = {\int }_{0}^{2 π} {\int }_{0}^{π} {\int }_{0}^{{r}_{c}} {r}^{2} sin θ \cdot {C}_{( {l}_{f} , {m}_{f} ) ( {l}_{i} , {m}_{i} )}^{( {l}_{0} , {m}_{o} )} \cdot {R}_{{c}_{i} {c}_{0}}^{( {l}_{i} , {l}_{f} )} ( {r}_{a} ) \cdot {Y}_{{m}_{f}}^{( {l}_{f} )} ( θ , ϕ ) \cdot {I}_{{c}_{i} {m}_{i}}^{( {l}_{i} )} ( r , θ , ϕ ) drd θ d ϕ \qquad Equation 9$$

where O_{ac}_{ₒ}ₘ_{ₒ}^{(l}^{ₒ}⁾ denotes an output at node a for an output channel c₀ for a rotation order l₀ and a representation index m₀. Repeated indices of Equation 9 imply summation. In some embodiments, the number of the input channels, cᵢ, and the number of the output channels, cₒ, of Equation 9 may differ. Equation 9 represents an analytical expression of the rotationally equivariant convolution operation. In alternative embodiments, other suitable analytical expression of the rotationally equivariant convolution operation may be used.

Numerical solution techniques can be used to evaluate the analytical expression of Equation 9. For example, Guassian quadrature can be used to express Equation 9 as an approximate summation. The approximate summation can represent a substantially rotationally equivariant form of the convolution of the CNN, which may take the form of Equation 10.

$${O}_{a {c}_{0} {m}_{0}}^{( {l}_{0} )} \approx \frac{{π}^{2} {r}_{c}}{4} {\sum }_{α = 1}^{{n}_{gp , α}} {\sum }_{β = 1}^{{n}_{gp , β}} {\sum }_{γ = 1}^{{n}_{gp , γ}} {w}_{α} {w}_{β} {w}_{γ} \cdot {\tilde{r}}_{a , γ}^{2} sin {\tilde{θ}}_{β} \cdot {C}_{( {l}_{f} , {m}_{f} ) ( {l}_{i} , {m}_{i} )}^{( {l}_{0} , {m}_{o} )} \cdot {C}_{{c}_{i} {c}_{0}}^{( {l}_{i} , {l}_{f} )} ( {\tilde{r}}_{a , γ} ) \cdot {Y}_{{m}_{f}}^{( {l}_{f} )} ( {\tilde{θ}}_{β} , {\tilde{ϕ}}_{a} ) \cdot {I}_{{c}_{i} {m}_{i}}^{( {l}_{i} )} ( {\tilde{r}}_{a , γ} , {\tilde{θ}}_{β} , {\tilde{ϕ}}_{α} ) \qquad Equation 10$$

where n_{gp,γ}, n_{gp,β}, and n_{gp,γ} are numbers of Gauss points with spherical coordinates \tilde{r}_{a,γ}, \tilde{θ}_{β}, and \tilde{ϕ}_{α}, the spherical coordinates can be represented by:

$${\tilde{r}}_{a , γ} = \frac{{r}_{c}}{2} ( {ξ}_{γ} + 1 ) , {\tilde{θ}}_{β} = \frac{π}{2} ( {ξ}_{β} + 1 ) ,$$

and \tilde{ϕ}_{α}=ϕ(ξ_{α}+1); w_{α}, w_{β}, and w_{γ} are Gauss weights; and I_{c}_{ᵢ}ₘ_{ᵢ}^{(l}^{ᵢ}⁾(\tilde{r}_{a,γ}, \tilde{θ}_{β}, \tilde{ϕ}_{α}) is an input field to a particular convolutional neuron. Variables ξ_{α}, ξ_{β}, and ξ_{γ} can represent positions of the Gauss points within an interval of [−1, 1]. Further, a tilde depicted over variables indicates evaluation in a physical domain. The absence of a tile over variables implies evaluation in a parent domain. As discussed above, the stencil tensor, S, may be a collection of points based on Gaussian quadrature. For example, Gauss points n_{gp,γ}, n_{gp,β}, and n_{gp,γ} may be collected together to define an n_{gp,γ}×n_{gp,β}×n_{gp,γ} dimensional stencil tensor S_{αβγ}.

The finite element method can use elemental shape functions. The elemental shape functions can be defined in a parent domain of each element, where the element can have a regular geometry. Alternatively, the elemental shape functions can be defined in the physical domain of a problem to be solved, where each element may have an irregular geometry. A mapping function can translate between the parent domain and the physical domain. For example, an isoparametric mapping function can have the form of Equation 11.

$${x}_{i} ( {ξ}_{i} ) = {\sum }_{e} {\sum }_{n ∈ e} {X}_{i}^{n} {N}^{ne} ( {ξ}_{i} ) \qquad Equation 11$$

where Xᵢⁿ is the i-th coordinate of node n in the physical domain and N^{ne}(ξᵢ) is an elemental shape function for node n and element e evaluated at the parent domain coordinate ξᵢ. The relationship between the parent domain and the physical domain can therefore be represented by Ñ^{ne}(xᵢ)=N^{ne}(ξᵢ(xᵢ)). An inverse isoparametric function can be used to translate from the physical domain to the parent domain. For example, ξᵢ(xᵢ) can represent the inverse isoparamteric mapping function (i.e., an inverse parametric map).

The expression I_{c}_{ᵢ}ₘ_{ᵢ}^{(l}^{ᵢ}⁾(\tilde{r}_{a,γ}, \tilde{θ}_{β}, \tilde{ϕ}_{α}) of Equation 10 can be input to a particular convolution neuron, for example using Equation 4, and can be further evaluated using the inverse isoparametric mapping function by way of the pre-computed stencil convolution tensor. The method is similar to that described above in relation to Equation 3; however, one difference being that stencil points are chosen based on Gauss quadrature instead of arbitrarily. Additionally, Equation 10 can therefore be implemented to enable a rotationally equivariant finite-element-based physics-informed neural network.

According to various embodiments, training the surrogate model may comprise, at 113, applying and/or training a surrogate model to a plurality of finite elements of the one or more finite elements.

According to various embodiments, training the surrogate model may comprise, at 114, constructing a training case. According to various embodiments, each training case may correspond to one or more ingredients necessary to establish a finite element problem. According to various embodiments, the one or more ingredients may comprise a finite element mesh of a chosen geometry; one or more constitutive models to describe one or more substance behaviors in the one or more constitutive models; a set of boundary conditions; a set of source terms; and/or a set of body forces, among other suitable ingredients.

A backward computation process can be used during training. Further, training the surrogate model can occur at certain intervals. Each interval can be an epoch. For example, backward propagation of errors, also known as backpropagation, can be used to update variables that control learning during neural network. The variables that control learning can be hyperparameters. During backpropagation, neural network training may further utilize the tangent stiffness matrix, K_{T}. For linear problems, the tangent stiffness matrix, K_{T}, may be computed once during a training run. For non-linear problems, the tangent stiffness matrix, K_{T}, may be computed at each of the training epochs. In alternative embodiments, the tangent stiffness matrix, K_{T}, may be recomputed for a suitable number of the epochs.

During backpropagation, derivatives of the loss function (e.g., Equation 1) may be computed with respect to the plurality of solution vectors, d, for the neural network. For the finite element PINN (FE-PINN), the derivatives may have the form of Equation 12:

$$\frac{\partial ℒ}{\partial d} = {K}_{T} \frac{R}{‖ R ‖} \qquad Equation 12$$

where R is a residual vector, which may have the form: R=P(d)−F; and K_{T} is the tangent stiffness matrix, which may have the form:

$${K}_{T} = \frac{\partial R}{\partial d} .$$

For linear problems, the stiffness matrix, K, may be the tangent stiffness matrix, K_{T}. (i.e., K=K_{T}).

According to various embodiments, predictions for new cases which the finite element PINN (FE-PINN) was not trained on may be evaluated to determine a predictive accuracy of the FE-PINN. According to various embodiments, when performance is not satisfactory (e.g., when prediction errors are too large), then the training set may be augmented and training repeated. According to various embodiments, the FE-PINN code may be configured to load training cases into memory and then may be configured to train the neural network until a training error is satisfactory.

This approach does not require generation of training data, decreasing computing power and memory storage requirements to solve for physical problems, thus improving upon existing technologies. This approach is further configured to efficiently leverage existing computational and modeling infrastructure when training neural-network-based surrogate models. According to various embodiments, using this approach, a major advantage of using FEM to train a PINN is that boundary condition enforcement is automatically established using basic FEM approaches. For essential boundary conditions, the associated nodal degrees of freedom may be removed from the system of equations and replaced by a set of conjugate forces. For natural boundary conditions, additional forces may be included in the force vector. According to various embodiments, no additional approaches need to be developed, and no additional loss terms are necessary, as in the case of weak boundary condition enforcement.

According to various embodiments, this approach may be configured to enable training a PINN which allows for variable geometry and boundary conditions, providing a generalized PINN which, after proper training, can provide a solution for a problem of interest. Problem geometry may be specified by providing all nodal coordinates as input to a network. Similarly, boundary conditions may be specified by inputting nodal values as an input.

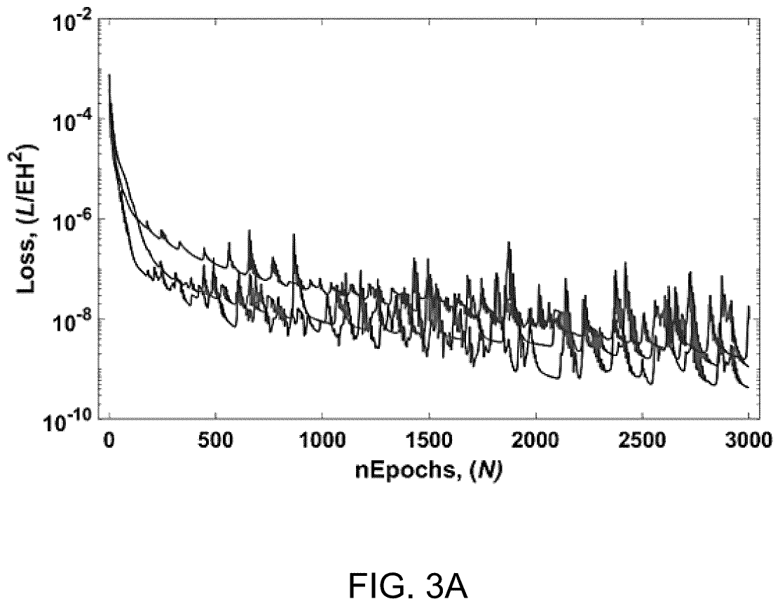

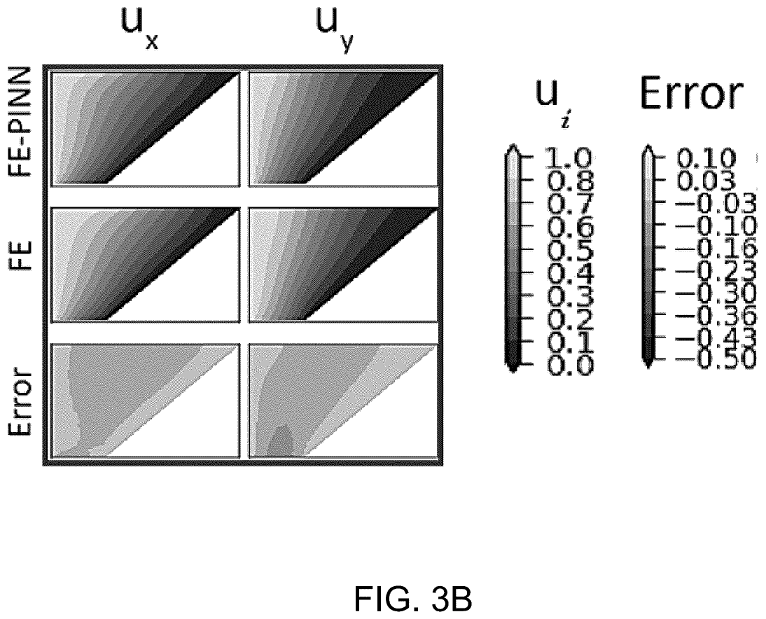

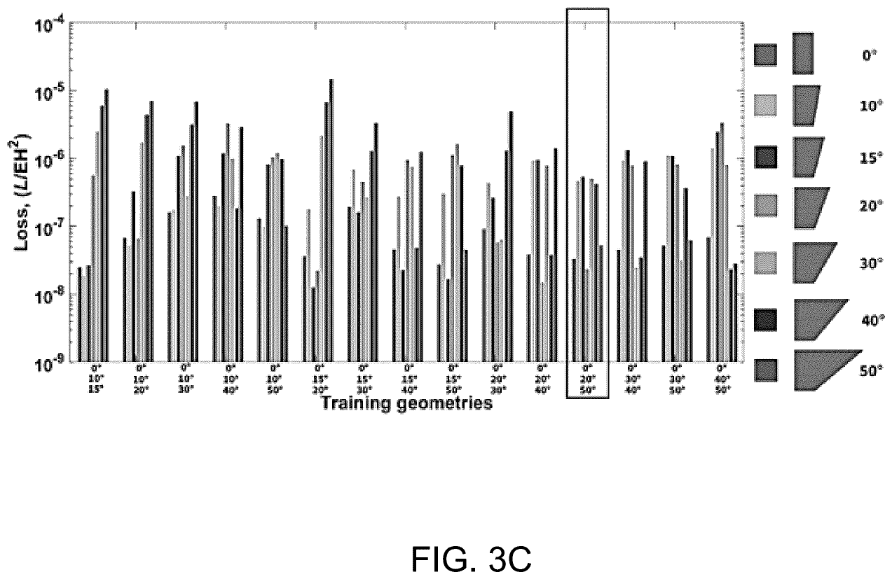

For example, using this approach, loading a wedged block geometry with varying wedge angle loading by a vertical displacement may be simulated. FIGS. 3A-3C show example results for such a simulation for a range of wedge angles, demonstrating that, by training on three wedged block geometries, reasonable predictions may be made. Further, FIGS. 3A-3C indicate that the FE-PINN may be able to learn multiple geometries at the same time without compromising training convergence.

As shown in FIGS. 3A-3C, loss convergence during training (FIG. 3A), solution fields from FEM and a trained FE-PINN (FIG. 3B), and an FE-PINN error for wedged block geometries using FE-PINNs trained on different combinations of three geometries (FIG. 3C) are illustratively depicted.

Referring now to FIG. 4, an illustration of an example architecture for a computing device 400 is provided.

The hardware architecture of FIG. 4 represents one example implementation of a representative computing device configured to perform one or more methods and means for training PINN surrogate models to model physical problems, as described herein. As such, the computing device 400 of FIG. 4 implements at least a portion of the method(s) described herein (for example, method 100 of FIG. 1).

Some or all components of the computing device 400 can be implemented as hardware, software and/or a combination of hardware and software. The hardware includes, but is not limited to, one or more electronic circuits. The electronic circuits can comprise, but are not limited to, passive components (e.g., resistors and capacitors) and/or active components (e.g., amplifiers and/or microprocessors). The passive and/or active components may be adapted to, arranged to and/or programmed to perform one or more of the methodologies, procedures, or functions described herein.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise one or more input devices and output devices, which facilitate user-software interactions for controlling operations of the computing device 400. The input devices include, but are not limited to, a physical and/or touch keyboard 450. The input devices can be connected to the computing device 400 via a wired or wireless connection (e.g., a Bluetooth® connection). The output devices may comprise, but are not limited to, a speaker 452, a display 454, and/or light emitting diodes 456.

At least some of the hardware entities 414 may be configured to perform actions involving access to and use of memory 412, which can be a Random Access Memory (RAM), a disk driver and/or a Compact Disc Read Only Memory (CD-ROM), among other suitable memory types. Hardware entities 414 can include a disk drive unit 416 comprising a computer-readable storage medium 418 on which is stored one or more sets of instructions 420 (e.g., programming instructions such as, but not limited to, software code) configured to implement one or more of the methodologies, procedures, or functions described herein. The instructions 420 can also reside, completely or at least partially, within the memory 412 and/or within the CPU 406 during execution thereof by the computing device 400.

The memory 412 and the CPU 406 also can constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 620 for execution by the computing device 400 and that cause the computing device 600 to perform any one or more of the methodologies of the present disclosure. According to various embodiments, one or more computer applications 424 may be stored on the memory 412.

The features and functions described above, as well as alternatives, may be combined into many other different systems or applications. Various alternatives, modifications, variations or improvements may be made by those skilled in the art, each of which is also intended to be encompassed by the disclosed embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method for training physics-informed neural network (PINN) surrogate models to model a physical problem, comprising:
coupling, using a processor, one or more convolutional neural networks (CNNs) with a finite element method (FEM), comprising:
calculating, for a finite element mesh comprising a plurality of finite elements, an internal force vector, P, a force vector, F, and a tangent stiffness matrix, K_{T}, using the FEM, wherein each finite element comprises one or more finite element nodes; and
applying a CNN to the finite element mesh to obtain a solution to the physical problem,
wherein:
the CNN is trained on a loss function, and
the loss function incorporates the internal force vector, P, and the force vector, F.

2. The method of claim 1, wherein the plurality of finite elements represent a spatiotemporal variation of one or more physical quantities into which the physical problem can be divided.

3. The method of claim 1, wherein the loss function comprises:
$$ℒ ( d ) = ‖ P ( d ) - F ‖$$
wherein d denotes a solution vector of the physical problem.

4. The method of claim 3, wherein, when the physical problem comprises a linear physical problem, the internal force vector, P, comprises: P(d)=Kd, wherein K is a stiffness matrix.

5. The method of claim 3, wherein, when the physical problem comprises a non-linear physical problem, the applying the CNN to the finite element mesh comprises iteratively applying a CNN for each of a plurality of solution vectors, d.

6. The method of claim 3, wherein backpropagation is used to update hyperparameters by computing derivatives of the loss function with respect to a plurality of solution vectors, d.

7. The method of claim 6, wherein the derivatives of the loss function with respect to the plurality of solution vectors comprises:
$$\frac{\partial ℒ}{\partial d} = {K}_{T} \frac{R}{‖ R ‖}$$
wherein:
R is a residual vector, comprising: R=P(d)−F; and
K_{T} is a tangent stiffness matrix, comprising:
$${K}_{T} = \frac{\partial R}{\partial d} .$$

8. The method of claim 1, wherein the applying the CNN comprises applying a convolutional operator, using a stencil tensor, S, to perform one or more convolutions.

9. The method of claim 8, wherein:
the stencil tensor, S, is a collection of points defined based on Gaussian quadrature, and
one or more convolutions of the CNN are enabled by placing the stencil tensor over top of a finite element node, of one or more finite element nodes, and then evaluating a field at each of one or more stencil points using an inverse isoparametric map.

10. The method of claim 8, wherein the convolution operator is substantially rotationally equivariant.

11. The method of claim 10, wherein the convolution operator comprises:
$${O}_{{ac}_{0} {m}_{0}}^{( {l}_{0} )} \approx \frac{{π}^{2} {r}_{c}}{4} {\sum }_{α = 1}^{{n}_{gp , α}} {\sum }_{β = 1}^{{n}_{gp , β}} {\sum }_{γ = 1}^{{n}_{gp , γ}} {w}_{α} {w}_{β} {w}_{γ} \cdot {\tilde{r}}_{a , γ}^{2} sin {\tilde{θ}}_{β} \cdot$$
$${C}_{( {l}_{f} , {m}_{f} ) ( \begin{matrix}{l}_{i} & {m}_{i} )\end{matrix}}^{( {l}_{0} , {m}_{o} )} \cdot {R}_{{c}_{i} {c}_{0}}^{( {l}_{i} , {l}_{f} )} ( {\tilde{r}}_{a , γ} ) \cdot {Y}_{{m}_{f}}^{( {l}_{f} )} ( {\tilde{θ}}_{β} , {\tilde{ϕ}}_{α} ) \cdot {I}_{{c}_{i} {m}_{i}}^{( {l}_{i} )} ( {\tilde{r}}_{a , γ} , {\tilde{θ}}_{β} , {\tilde{ϕ}}_{α} )$$
wherein:
l is a rotation order, c is an input channel index, and m is a representation index;
O_{ac}_{ₒ}ₘ_{ₒ}^{(l}^{ₒ}⁾ is an output at node a for an output channel cₒ, the rotation order lₒ, and the representation index m₀;
a number of the input channels, cᵢ, and a number of the output channels, cₒ, can differ;
r_{c} is a cut-off radius within a spherical neighborhood of node a;
\tilde{r}_{a,γ}, \tilde{θ}_{β}, and \tilde{ϕ}_{α} are spherical coordinates, the spherical coordinates comprising:
$${\tilde{r}}_{a , γ} = \frac{{r}_{c}}{2} ( {ξ}_{γ} + 1 ) , {\tilde{θ}}_{β} = \frac{π}{2} ( {ξ}_{β} + 1 ) ,$$
and \tilde{ϕ}_{α}=ϕ(ξ_{α}+1);
where: ξ_{α}, ξ_{β}, and ξ_{γ} are positions of Gauss points within an interval of [−1, 1];
n_{gp,γ}, n_{gp,β}, and n_{gp,γ} are numbers of the Gauss points, evaluated at spherical coordinates \tilde{r}_{a,γ}, \tilde{θ}_{β}, and \tilde{ϕ}_{α};
w_{α}, w_{β}, and w_{γ} are Gauss weights;
C₍ₗ_{_{f}}_{,m}_{_{f}}₎₍ₗ_{ᵢ}_{,m}_{ᵢ}₎^{(l}^{ₒ}^{,m}^{ₒ}⁾ are Clebsch-Gordon coefficients;
R_{c}_{ᵢ}_{c}_{ₒ}^{(l}^{ᵢ}^{,l}^{_{f}}⁾(r_{a,γ}) is a radial weight function;
Yₘ_{_{f}}^{(l}^{_{f}}⁾(\tilde{θ}_{B}, \tilde{ϕ}_{α}) is a spherical harmonics component; and
l_{c}_{ᵢ}ₘ_{ᵢ}^{(l}^{ᵢ}⁾(\tilde{r}_{a,γ}, \tilde{θ}_{β}, \tilde{ϕ}_{α}) is an input field to a particular convolutional neuron.

12. The method of claim 11, wherein the radial weight function is expanded in a set of basis functions, the basis functions comprising:
$${R}_{{c}_{i} {c}_{0}}^{( {l}_{i} , {l}_{f} )} ( r ) = {\sum }_{p = 1}^{{p}_{max}} {α}_{{c}_{i} {c}_{o} p}^{( {l}_{f} , {l}_{i} )} {g}_{p} ( r )$$
wherein:
gₚ(r) is a p-th radial basis function;
r is a radius; and
α_{c}_{ᵢ}_{c}_{ₒ}ₚ^{(l}^{_{f}}^{,l}^{ᵢ}⁾ are trainable parameters.

13. The method of claim 12, wherein the set of basis functions comprises cosines and Chebyshev polynomials, the set of basis functions comprising:
$${g}_{1} ( r ) = 1 + cos ( \frac{π r}{{r}_{c}} ) ; \\ {g}_{p} ( r ) = \frac{1}{4} [ 1 - {T}_{p - 1} ( x ) ] [ 1 + cos ( \frac{π r}{{r}_{c}} ) ] , p \geq 2 ; and \\ x = 1 - 2 ( \frac{exp ( - λ ( r / {r}_{c} - 1 ) - 1 )}{exp ( - λ ) - 1} ) ;$$
wherein:
Tₚ is a p-th Chebyshev polynomial of a first kind; and
λ is a parameter.

14. The method of claim 11, wherein the input field is specified using a finite element approximation, the input field comprising:
$${I}_{cm}^{( l )} ( x ) = {\sum }_{e} {\sum }_{n ∈ e} {d}_{cmn}^{( l )} {\tilde{N}}^{ne} ( x )$$
wherein:
d_{cmn}^{(l)} is a nodal value for the field I_{cm}^{(l)} at a node n;
Ñ^{ne}(⋅) is a shape function evaluated in a physical domain for the node n contained in an element e; and
summations are performed for all the elements, e, and all the nodes, n.

15. The method of claim 10, wherein the convolution operator is a numerical approximation of an analytical expression, the analytical expression comprising:
$${O}_{{ac}_{0} {m}_{0}}^{( {l}_{0} )} = {\int }_{0}^{2 π} {\int }_{0}^{π} {\int }_{0}^{{r}_{c}} {r}^{2} sin θ \cdot {C}_{( {l}_{f} , {m}_{f} ) ( {l}_{i} , {m}_{i} )}^{( {l}_{0} , {m}_{o} )} \cdot$$
$${R}_{{c}_{i} {c}_{0}}^{( {l}_{i} , {l}_{f} )} ( {r}_{a} ) \cdot {Y}_{{m}_{f}}^{( {l}_{f} )} ( θ , ϕ ) \cdot {I}_{{c}_{i} {m}_{i}}^{( {l}_{i} )} ( r , θ , ϕ ) drd θ d ϕ$$
wherein: rₐ is a radial distance from node a, comprising: rₐ=∥x−xₐ∥.

16. The method of claim 9, wherein an isoparametric mapping function comprises:
$${x}_{i} ( {ξ}_{i} ) = {\sum }_{e} {\sum }_{n ∈ e} {X}_{i}^{n} {N}^{ne} ( {ξ}_{i} )$$
wherein:
Xᵢⁿ is an i-th coordinate of the node n in a physical domain, and N^{ne}(ξᵢ) is an elemental shape function evaluated at a parent domain coordinate ξᵢ; and
a relationship between the parent domain and the physical domain comprises:
$${\tilde{N}}^{ne} ( {x}_{i} ) = {N}^{ne} ( {ξ}_{i} ( {x}_{i} ) )$$
wherein:
the inverse isoparametric map comprises: ξᵢ(xᵢ).

17. The method of claim 1, wherein the calculating, for each finite element, the internal force vector, P, the force vector, F, and the tangent stiffness matrix, K_{T}, using the FEM, comprises:
training a surrogate model to the one or more finite elements.

18. The method of claim 1, wherein:
the calculating, for the finite element mesh, the internal force vector, P, the force vector, F, and the tangent stiffness matrix, K_{T}, using the FEM, comprises constructing a training case, and
each training case corresponds to one or more ingredients necessary to establish a finite element problem.

19. The method of claim 18, wherein the one or more ingredients comprise one or more of:
a finite element mesh of a chosen geometry;
one or more constitutive models to describe one or more substance behaviors in the one or more constitutive models;
a set of boundary conditions;
a set of source terms; and
a set of body forces.

20. A system for training physics-informed neural network (PINN) surrogate models to model physical problems, comprising:
a computing device, comprising a processor and a memory configured to store programming instructions, wherein the programming instructions, when executed by the processor, are configured to cause the processor to:
couple one or more convolutional neural networks (CNNs) with a finite element method (FEM), comprising:
calculating, for a finite element mesh comprising a plurality of finite elements, an internal force vector, P, a force vector, F, and a tangent stiffness matrix, K_{T}, using the FEM, wherein each finite element comprises one or more finite element nodes; and
applying a CNN to the finite element mesh to obtain a solution to the physical problem,
wherein:
the CNN is trained on a loss function, and
the loss function incorporates the internal force vector, P, and the force vector, F.
